(19) United States
(12) Patent Application Publication
(10) Pub. No.: US 2005/0177823 A1
(43) Pub. Date: Aug. 11, 2005

(54) License management

(75) Inventor: Hiroaki Miyake, Tokyo-to (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY (US)

(21) Appl. No.: 11/051,288

(22) Filed: Feb. 4, 2005

(30) Foreign Application Priority Data
Feb. 6, 2004 (JP) 2004-031202

(51) Int. Cl. G06F 9/45

(52) U.S. Cl. 717/159

(57) ABSTRACT

Licenses to an OS are managed for each recording medium used for recording the OS. A removable recording medium having the OS recorded thereon is read and activated by a computer and allows the computer to: read recording medium identification data from the recording medium; read, from the recording medium, source identification data for designating a recording medium that is permitted to function as a source for activating the OS; detect a disagreement state wherein the recording medium designated based on the source identification data does not match the recording medium identified based on the recording medium identification data; and, on condition that the disagreement state is not detected, permit the computer to activate and employ the OS, and for, on condition that the disagreement state is detected, limiting the functions of the OS.

### BACKGROUND OF THE INVENTION

The present invention relates to an operating system, a license management server, a license management method, a license management program and a recording medium therefor. Particularly, the present invention relates to an operating system, for managing the license for an operating system that is recorded on a removable recording medium and is read and activated by a computer into which the recording medium is loaded, and a license management server, a license management method, a license management program and a recording medium therefor.

The technique for preventing the illegal copying from a recording medium, data is generated based on random pattern data obtained by a random physical phenomenon occurring on a recording medium, and is recorded on the recording medium. Then, an apparatus for accessing the recording medium examines the recording medium based on the random pattern data and the medium identification data. On condition that the apparatus does not verify that the recording medium is legal, the apparatus inhibits data recording or data reproduction for the recording medium.

A technique for preventing the illegal use of software is disclosed in patent document 2. According to patent document 2, data for a license issued for software are stored in a portable contents reproduction apparatus. And on condition that a computer, for example, is to install or execute the software, the computer, to which the contents reproduction apparatus is attached, must obtain the data and use them to authenticate the license for the software.

[Patent document 1] PCT WO 00/4680

[Patent document 2] JP-A-2001-216357

### SUMMARY OF THE INVENTION

Conventionally, an operating system (hereinafter referred to as an “OS”) is installed on each computer. Therefore, in general, license management for an OS is performed based on information inherent to a source recording medium for the OS or to the computer wherein the OS is installed. Since a user's operating environment, i.e., an OS, an application program and/or a customized environment, can be employed only for a specific computer, a user who wishes to use his or her operating environment at various destinations must carry a notebook computer.

The present invention is provided in order to permit a user to use his or her operating environment at a transitory destination without having to carry a notebook computer. More specifically, according to the present invention, the operating environment, including the OS, is recorded on a portable recording medium, and to activate the OS and enable the operating environment, the recording medium need only be loaded into a computer at a transitory destination.

On condition that a computer is employed in this way, it is possible to activate an OS using an arbitrary computer at a transitory destination, so that license management for the OS can not be performed using information inherent to the computer on which employed. On condition that this is the condition under which the OS is employed, to protect the copyright, the OS, which is recorded on a specific recording medium, must be prevented from being illegally copied to another recording medium and put to use.

On condition that the technique disclosed in patent document 1 is employed to prevent the illegal copying of an OS to another recording media, the following problems occur. According to patent document 1, an apparatus that accesses the recording medium examines the recording medium, and based on the examination results, inhibits the reproduction of data recorded on the recording medium. This technique would be effective were it the case that all manufacturers fabricated only products, such as DVD recorders and DVD players, wherein functions for preventing illegal copying is installed during production. However, since a common, versatile architecture has not been adopted for computers, and since they can even be assembled by users, to assume that all new computers will be equipped with functions that prevent illegal copying is unrealistic.

Thus, it is preferable that various types of recording media, Compact Flash (trademark), Microdrive (trademark) and USB memory devices, for example, be available for OS recording. However, on condition that the technique in patent document 1 is employed, depending on the type of recording medium involved, random pattern data, produced by random physical phenomena occurring on recording media, are not detected.

The technique disclosed in patent document 2, for the recording of computer software to be installed or executed, does not provide license management for software recorded on a recording medium that has been loaded into a computer. Therefore, the technique in patent document 2 also can not solve the problems solved by the present invention, according to which a user, to activate and use his or her operating environment, loads a portable recording medium into a computer at a transitory destination.

To resolve the above described shortcomings, one purpose of the present invention is the provision of an operating system, a license management server, a license management method, a license management program and a recording medium therefor. This purpose is achieved by employing a combination of the features described in the independent claims of the present invention, and dependent claims that define further, advantageous procedural examples. Aspects include producing computer executable program code and providing the program code to be deployed to and executed on a first computer system, the program code including operating system code which is to be written on a removable recording medium and executed by a bootable computer into which the recording medium is loaded. The first computer and the bootable computer can be the same computer.

According to a first aspect of the present invention, an operating system, which is recorded on a removable recording medium and which is read and activated by a computer into which the recording medium is loaded, permits the computer to function as:
a recording medium identification data reader, for reading, from a storage area on a recording medium, recording medium identification data for identifying the recording medium on which the operating system is recorded;
a source identification data reader for reading, from a storage area on the recording medium, source identification information, recorded in correlation with the operating system, designating the recording medium that is permitted to serve as a data source for activating the operating system;
a recording medium disagreement detector, for detecting a recording medium disagreement state wherein the recording medium designated by the source identification data does not match the recording medium identified by the recording medium identification data; and
a function controller, for permitting the computer, on condition that a recording medium disagreement state is not detected, to activate the operating system and to set the operating system to an enabled state, or for disabling, on condition that a recording medium disagreement state is detected, at least one of the functions of the operating system that are available on condition that a recording medium disagreement state is not detected. Further, a recording medium is provided on which the operating system is recorded.

According to a second aspect of the present invention, a license management server, which manages a license for an operating system, recorded on a removable recording medium, that is read and activated by a computer into which the recording medium is loaded, comprises:
a management data receiver for receiving, from a recording medium management server that manages the recording medium, recording medium identification data, for identifying the recording medium, that are recorded in advance in a storage area on the recording medium;
a license inquiry receiver for receiving, from the computer that activates the operating system by accessing the recording medium, a license authentication request including recording medium identification data that are read from a storage area on the recording medium;
a license determination unit, for determining, on condition that the recording medium identified by the recording medium identification data received by the management data reception unit matches the recording medium designated by the recording medium identification data included in the license authentication request, that by accessing the recording medium the operating system may be activated and set in an enabled state; and
a license determination results transmitter, for permitting, on condition that it is determined that by accessing the recording medium the operating system may be activated and set in an enabled state, the computer to activate and set the operating system in an enabled state by accessing the recording medium. Further provided are a license management method, a license management program and a recording medium therefor.

According to a third aspect of the present invention, a removable recording medium, on which is recorded an operating system that is to be read and activated by a computer, comprises:
a recording medium identification data storage area, wherein recording medium identification data for identifying the recording medium are stored;
an operating system storage area, wherein the operating system is stored; and
a source identification data storage area, wherein source identification data, for designating a recording medium that is permitted to act as a source for the activation of the operating system, are stored in correlation with the operating system,
wherein, on condition that the computer does not detect a recording medium disagreement state, wherein the recording medium designated by the source identification data does not match the recording medium identified by the recording medium identification data, the operating system permits the computer to activate and set the operating system in an enabled state, and
wherein, on condition that the computer detects a recording medium disagreement state, the operating system permits the computer to disable at least one of the functions of the operating system that are set to the enabled state on condition that the computer does not detect a recording medium.

The above is merely an overview and does not limit the invention. As will be seen, additional features are set forth in the specification and the appended claims. The invention includes both combinations and subcombinations of the features described above and the additional features set forth in the specification and appended claims.

According to the various aspects of the present invention, the license management process for the operating system can be performed for each recording medium on which the operating system is recorded.

### BRIEF DESCRIPTION OF THE DRAWINGS

Some of the purposes of the invention having been stated, others will appear as the description proceeds, when taken in connection with the accompanying drawings, in which:

FIG. 1 is a diagram showing the configuration of a license management system according to one embodiment of the present invention;

FIG. 2 is a diagram showing the functional configuration of an OS run by a computer according to the embodiment;

FIG. 3 is a diagram showing the configuration of a license management server according to the embodiment;

FIG. 4 is a flowchart showing the OS installation processing according to the embodiment;

FIG. 5 is a flowchart showing the OS activation processing according to the embodiment;

FIG. 6 is a flowchart showing the OS updating processing according to the embodiment;

FIG. 7 is a flowchart showing the license certification processing performed by a license management server according to the embodiment; and

FIG. 8 is a diagram showing the hardware configuration of a computer according to the embodiment.

### DETAILED DESCRIPTION OF THE ILLUSTRATIVE EMBODIMENTS

While the present invention will be described more fully hereinafter with reference to the accompanying drawings, in which a preferred embodiment of the present invention is shown, it is to be understood at the outset of the description which follows that persons of skill in the appropriate arts may modify the invention here described while still achieving the favorable results of this invention. Accordingly, the description which follows is to be understood as being a broad, teaching disclosure directed to persons of skill in the appropriate arts, and not as limiting upon the present invention.

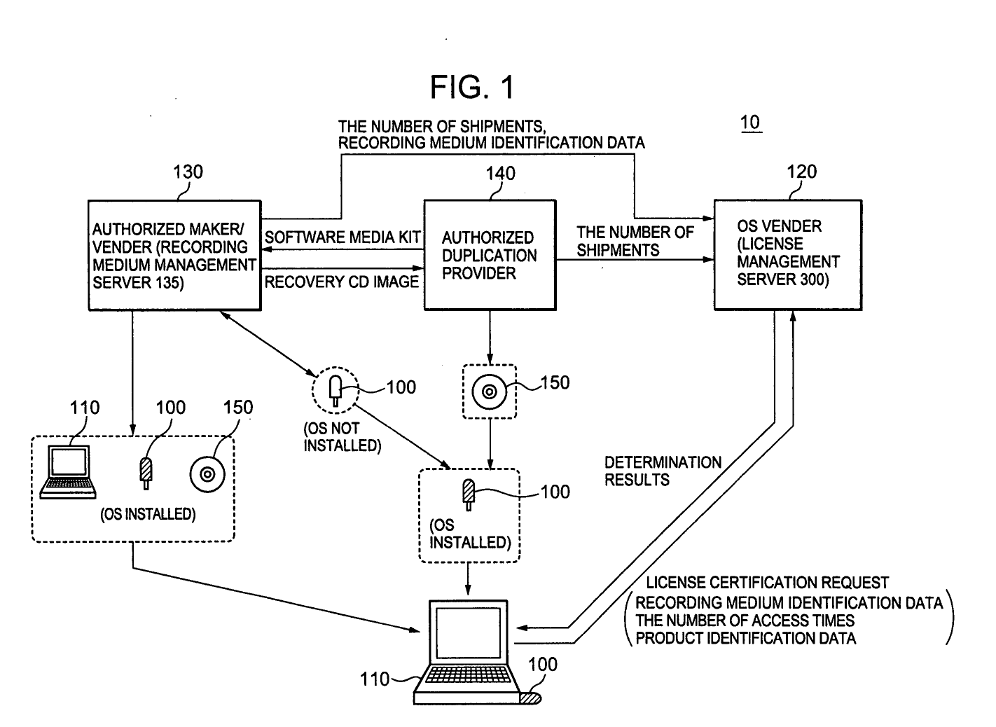

Referring now more particularly to the accompanying drawings, in which like numerals indicate like elements or steps throughout the several views, FIG. 1 is a diagram showing the configuration of a license management system 10 according to the embodiment. The license management system 10 manages a license for an OS that is recorded on a removable recording medium 100 and is read out and activated by a computer 110 into which the recording medium 100 has been loaded. The recording medium 100, on which is recorded the OS for which the license is managed by the license management system 10, can be carried by a user while on a business or a private trip and loaded into and accessed by computers 110 installed at various transitory destinations, such as homes, companies and other sites visited. A computer 110, into which the recording medium 100 is loaded, reads out and activates the OS recorded thereon, and sets the OS in the enabled state. Thus, the user can employ, on any computer 110, the OS, an application program and/or a customized environment that is stored on the recording medium 100.

The license management system 10, which is the development source for the OS, includes an OS vender 120, for managing the license for an OS; a duplication provider 140, for providing a software product medium 150, on which is recorded a product such as an OS or an application program; a maker/vender 130, for manufacturing or selling the recording medium 100 whereon the OS, for example, is recorded; and a computer 110 for activating the OS.

The OS vender 120, for which a license management server 300 is provided that manages the license for an OS, develops the program for the OS and assigns duplication and sale rights for the OS to the duplication provider 140. The duplication provider 140 produces and sells the software product medium 150, including the OS, and reports to the OS vender 120 the number of OSs shipped and pays a corresponding copyright charge.

The maker/vender 130 manufactures or sells the recording medium 100 on which the OS employed for this embodiment is reproduced. In a portion of the storage area on the recording medium 100, the maker/vender 130 records, recording medium identification data for identifying the recording medium 100 that is used for installing the OS. At this time, before adding the recording medium identification data to the recording medium 100, the maker/vender 130 encrypts the data in order to identify a recording medium 100 on which the recording medium identification data is prepared and recorded by a third party whose intent is the illegal use of the OS.

Ordinarily, the maker/vender 130 sells a recording medium 100 on which an OS has not yet been stored. However, the maker/vender 130 may also purchase from a duplication provider 140 a software media kit that includes an OS, reproduce the OS on a recording medium 100, and bundle the recording medium 100, as a software product medium 150, for sale with a computer 110. In this case, it is the maker/vender 130 who reports the number of OSs shipped to the OS vender 120 and pays a corresponding copyright fee.

After selling a recording medium 100, the maker/vender 130 provides for the OS vender 120 the recording medium identification data recorded thereon. More specifically, also provided for the maker/vender 130 is a recording medium management server, for managing a recording medium 100, that transmits recording medium identification data for a recording medium 100 to the license management server 300 of the OS vender 120. Thus, the license management server 300 can authenticate the license of the OS stored on that recording medium 100. Furthermore, the maker/vender 130 may provide for the duplication provider 140 a recovery CD image, including an OS that is stored on the recording medium 100 that was sold, and may sell, through the duplication provider 140, a software product medium 150 as a recovery CD.

A user of the OS purchases the software product medium 150 and a recording medium 100 on which an OS has not been stored, and copies to the recording medium 100 the OS recorded on the software product medium 150 to obtain a recording medium 100 on which the OS is stored. During the installation processing, which is performed by an OS installation program, the computer 110 transmits a license authentication request to the license management server 300. It should be noted that the recording medium identification data for the recording medium 100 are included in the license authentication request, and based on these data, the license management server 300 determines whether to permit/prohibit a license and transmits the determination results to the computer 110. Upon receiving results indicating a license is permitted, the OS installation program, executed by the computer 110, continues the installation processing, storing the OS on the recording medium 100 and setting it to the operation enabled state.

The OS, recorded on the recording medium 100, can be activated by each computer 110 located at each transitory destination visited by the user, so that at each transitory destination, the operating environment of the user can be provided. In order to prevent the illegal usage of the OS, based on the recording medium identification data for the recording medium 100 from which the OS is read, and the recording medium identification data for the recording medium 100 that was used for the installation of the OS, the OS determines whether the recording medium 100 from which the OS is read matches the recording medium 100 designated as the source for activating the OS. On condition that a recording medium 100 other than the one used for the installation of the OS is employed to activate the OS, the use of at least one of the functions of the OS is prohibited. In this case, the activation process may also be halted and use of the entire OS disabled, so that all the OS functions are prohibited.

According to the license management system 10, the recording medium identification data recorded in advance on the removable recording medium 100, which can be loaded in a computer 110, is employed to store the OS on a specific recording medium 100. On condition that the contents of the recording medium 100 are illegally copied to another recording medium 100, and the illegal recording medium 100 is used to activate the OS, the use of part or all of the OS functions can be prohibited. As a result, in a situation wherein an OS stored on a recording medium 100 is activated by a computer 110 at each transitory destination, the copyright of the OS can be appropriately protected.

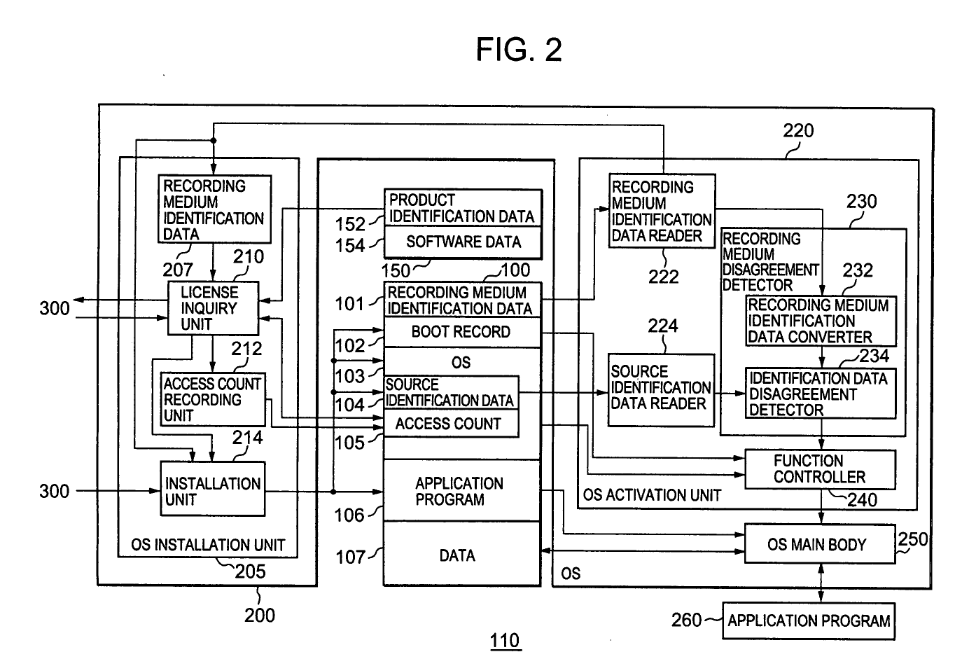

FIG. 2 is a diagram showing the functional configuration of an OS 200 used for the operation of a computer 110 according to the embodiment. The program for the OS 200 is executed by the computer 110 and permits the computer 110 to function as an OS installation unit 205, an OS activation unit 220 and an OS main body 250.

The OS installation unit 205 is provided by executing an installation program for an OS 200 that is included on a software product medium 150 distributed by either the maker/vender 130 or the duplication provider 140. Thus, an OS 200 stored on a recording medium 100 can be activated and employed. Furthermore, a recording medium 100 on which an OS 200 is not stored includes a recording medium identification data storage area 101, for storage of recording medium identification data, in which the maker/vender 130 stores, in advance, the recording medium identification data used to identify the recording medium 100. Therefore, to prevent the overwriting of the recording medium identification data stored by the maker/vender 130, it is preferable that the recording medium identification data storage area 101 be a write-once storage area.

The OS installation unit 205 includes a recording medium identification data determination unit 207, a license inquiry unit 210, an access count recording unit 212 and an installation unit 214. The recording medium identification data determination unit 207 determines whether the recording medium identification data, read by a recording medium identification data reader 222, satisfies a predesignated condition, and examines the validity of the recording medium identification data. More specifically, the recording medium identification data determination unit 207 employs means for examining the Checksum of the recording medium identification data to determine the form of the recording medium identification data stored on the recording medium 100. On condition that the recording medium identification data determination unit 207 determines that the recording medium identification data is not valid, the determination unit 207 halts the installation of the OS 200. And on condition that the recording medium identification data determination unit 207 determines that the recording medium identification data is valid, the determination unit 207 supplies the recording medium identification data to the license inquiry unit 210 and the installation unit 214.

The license inquiry unit 210 transmits a license authentication request to the license management server 300, from which it later receives determination results. More specifically, the license inquiry unit 210 transmits to the license management server 300 a license authentication request including recording medium identification data that was read by the recording medium identification data reader 222, which also functions as part of the OS activation unit 220. Upon receiving the license authentication request, the license management server 300 employs the included recording medium identification data to determine whether or not the license should be authenticated, and transmits the results of the determination to the license inquiry unit 210. In this manner, the license inquiry unit 210 obtains from the license management server 300 determination results representing whether or not the license has been authenticated.

At this time, the license inquiry unit 210 may also include in the license authentication request the number of times the OS 200 has accessed the license management server 300 and/or product identification data recorded in a product identification data storage area 152 on the software product medium 150. In this case, the license management server 300 performs the determination process based on the number of access times and/or the product identification data, in addition to the recording medium identification data that is included in the license authentication request, and transmits the results of the determination to the license inquiry unit 210.

The access count recording unit 212 counts the number of times the OS 200 accessed the license management server 300, and records the access times count in the access count storage area 105 on the recording medium 100. More specifically, on condition that the OS 200 is first stored on the recording medium 100, the access count recording unit 212 initializes the access count storage area 105, and thereafter, each time the OS 200, to obtain update data, accesses a Web site provided by the OS vender 120 or the license management server 300, the access count recording unit 212 updates the access times count stored in the access count storage area 105.

The installation unit 214 reads, from a software data storage area 154 on the software product medium 150, an OS boot program, for activating the OS 200, an OS main program, for permitting a user to employ the OS 200, and an application program distributed, together with the program for the OS 200, on the software product medium 150. Then, the installation unit 214 respectively stores the OS boot program, the main program for the OS 200 and the application program in a boot record 102, an OS storage area 103 and an application program storage area 106 on the recording medium 100.

Based on the recording medium identification data recorded in the recording medium identification data storage area 101 on the recording medium 100, the installation unit 214 generates source identification data for a source for activating the OS 200, and stores this data on the recording medium 100, together with the program for of the OS 200. In this case, the source identification data is information that is recorded on the recording medium 100, in correlation with the OS 200 that is also to be stored thereon, and that designates a recording medium 100 that is permitted to function as a source for activating the OS 200. The installation unit 214 for this embodiment employs means for encrypting the recording medium identification data, and changes the recording medium identification data to prevent inverse conversion and thus prevent the source identification from being obtained. Through this processing, the installation unit 214 prevents an unauthorized user, who has illegally recorded the OS 200 on another recording medium 100, from obtaining the recording medium identification data based on the contents of the source identification data storage area 104.

Further, on condition that the installation unit 214 receives from the license management server 300 determination results indicating the license has been authenticated, the installation unit 214, through the recording medium 100, activates the OS 200 and enables its usage. On condition that the installation unit 214 does not receive from the license management server 300 determination results indicating the license has been authenticated, it inhibits, through the recording medium 100, the use of the OS 200. Instead of the above process, during a period continuing until the determination results are received from the license manager 300, the installation unit 214 may inhibit the employment use by a user of part or all of the functions of the OS 200, and may permit the disabled functions to be used only after determination results are received indicating the license has been authenticated. Further, on condition that the determination results indicate the license has not been authenticated, the installation unit 214 may maintain the functions in the disabled state, or may inhibit the use of further, different functions.

The thus described OS installation unit 205 provides, for the recording medium 100, not only the recording medium identification data storage area 101, but also the boot record 102 used to record the boot program of the OS 200, the OS storage area 103 used to record the OS 200, the source identification data storage area 104 used to record, in correlation with the OS 200, the source identification data, the access count storage area 105 used to record the number of accesses, and the application program storage area 106 used to record the application program. A data storage area 107 used for storing data, such as user created files, may also be provided for the recording medium 100. The OS 200, which is activated from the program record 102 and the OS storage area 103, permits the computer 110 to function as the OS activation unit 220.

The OS activation unit 220 is provided on condition that the computer 110 reads and executes the OS boot program stored on the boot record 102 of the recording medium 100, and activates the OS 200 from the recording medium 100 that is permitted to function as the activation source for the OS 200. The OS activation unit 220 includes the recording medium identification data reader 222, a source identification data reader 224, a recording medium disagreement detector 230 and a function controller 240.

The recording medium identification data reader 222 reads recording medium identification data from the recording medium identification data storage area 101 on the recording medium 100 in order to identify the recording medium 100 on which the OS 200 is stored. The recording medium identification data reader 222 provides for the OS installation unit 205, at the time the OS 200 is installed, or for the recording medium disagreement detector 230, at the time the OS 200 is activated, the recording medium identification data, read from the recording medium identification data storage area 101, that is employed in common by the OS installation unit 205 and the OS activation unit 220. The source identification data reader 224 reads the source identification data for the OS 200 from the source identification data storage area 104 on the recording medium 100.

The recording medium disagreement detector 230 determines whether a recording medium 100 that is designated based on the source identification data read by the source identification data reader 224, matches a recording medium 100 that is identified based on the recording medium identification data read by the recording medium identification data reader 222. On condition that the recording medium 100 designated based on the source identification data does not match the recording medium 100 identified based on the recording medium identification data, the recording medium disagreement detector 230 determines the recording medium disagreement state exists.

The recording medium disagreement detector 230 includes a recording medium identification data converter 232 and an identification data disagreement detector 234. The recording medium identification data converter 232 performs the same conversion as that employed by the installation unit 214 to generate the source identification data, and converts the recording medium identification data read by the recording medium identification data reader 222. The identification data disagreement detector 234 determines the recording medium disagreement state exists on condition that the source identification data, which is read by the source identification data reader 224, does not match the recording medium identification data, which is obtained by the recording medium identification data converter 232.

On condition that the recording medium disagreement state is detected during the process whereby the computer 110 activates the OS 200, the function controller 240 halts the activation process. Thus, the function controller 240 inhibits the use of the OS 200 by the computer 110. On condition that the recording medium disagreement state is not detected, the function controller 240 continues the activation process and permits the computer 110 to operate the OS main body 250, which is operated after the activation of the OS 200 and is employed by the user.

Instead of the above process, on condition that the recording medium disagreement state is not detected, the function controller 240 may permit the computer 110 to activate the OS 200 and enable the use thereof. On condition that the recording medium disagreement state is detected, the function controller 240 may inhibit part of the functions of the OS 200. More specifically, on condition that the recording medium disagreement state is not detected, the function controller 240 permits the computer 110 to activate the OS main body 250. And on condition that the recording medium disagreement state is detected, the function controller 240 inhibits at least one of the functions of the OS 200 that are available on condition that the recording medium disagreement state is not detected.

According to the above explanation, the source identification data, for designating the recording medium 100 that is permitted to act as an activation source for the OS 200, is stored on the recording medium 100 with the OS 200. During the activation process for the OS 200, the OS 200, read from the recording medium 100 and activated, obtains the recording medium identification data for the recording medium 100, which is stored in advance on the recording medium 100, and the source identification data, which is recorded with the OS 200 at the installation time. Then, whether the OS 200 stored on the recording medium 100 should be activated is determined.

On condition that the OS 200 has been illegally copied to a different recording medium 100, the recording medium 100 designated based on the source identification data does not match the different recording medium 100. In this case, the OS 200 inhibits the use of part or all of its functions. Since the OS 200 performs this process regardless of which computer 100 activates the OS 200, the copyright for the OS 200 can also be appropriately protected on condition that the OS 200 is employed in the manner described in this embodiment.

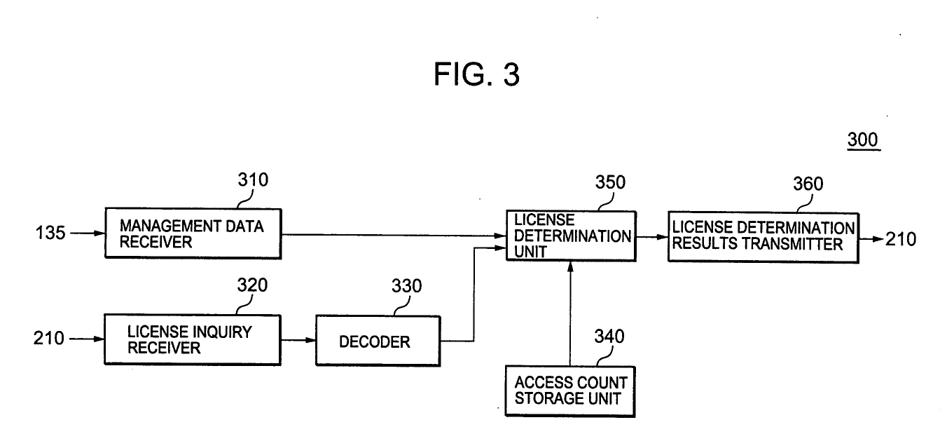

FIG. 3 is a diagram showing the configuration of the license management server 300 according to the embodiment. For the installation of the OS 200, the license management server 300 receives a license authentication request from the OS 200 that is operated by the computer 110. Then, the license management server 300 employs the recording medium identification data for the recording medium 100 to determine whether the activation and use of the OS 200 on the recording medium 100 should be permitted. Thereafter, the license management server 300 transmits the results obtained by the determination to the OS 200. Similarly, for updating the OS 200, the license management server 300 receives a license authentication request from the OS 200 that is operated by the computer 110. Then, the license management server 300 employs the recording medium identification data for the recording medium 100 to determine whether the activation and use of the updated version of the OS 200 on the recording medium 100 should be permitted. Thereafter, the license management server 300 transmits the results of the determination to the OS 200.

The license management server 300 includes a management data receiver 310, a license inquiry receiver 320, a decoder 330, an access count storage unit 340, a license determination unit 350, and a license determination results transmitter 360. The management data receiver 310 receives, from a recording medium management server 135, recording medium identification data that is recorded in advance in the recording medium identification data storage area 101 on the recording medium 100 in order to identify the recording medium 100. The license inquiry receiver 320 receives, from the computer 110 that activates the OS 200 or its updated version from the recording medium 100, a license authentication request that includes the recording medium identification data, which was read from the recording medium identification data storage area 101 on the recording medium 100. The license authentication request may include the access count recorded in the access count storage area 105 and/or the product identification data stored in the product identification data storage area 152.

The decoder 330 is provided on condition that the recording medium identification data has been encrypted and recorded in advance on the recording medium 100. The decoder 330 decodes the recording medium identification data that is included in the license certification request received by the license inquiry receiver 320, while the access count storage unit 340 stores the access count that the license management server 300 increments each time an OS 200 access occurs.

On condition that a recording medium 100 that is identified based on the recording medium identification data received by the management data receiver 310, matches a recording medium 100 that is designated based on the recording medium identification data included in the license certification request, the license determination unit 350 determines that the OS 200 or the updated version may be activated from the recording medium 100 and set to the enabled state. On condition that the recording medium identification data included in the license certification request is encrypted data, and on condition that the recording medium identification data received by the management data receiver 310 matches the recording medium identification data decoded by the decoder 330, the license determination unit 350 determines that the OS 200 or the updated version may be activated from the recording medium 100 and be set in the enabled state.

On condition that the license certification request includes the access count and/or the product identification data, the license determination unit 350 may employ the access count and/or the product identification data in addition to the condition wherein the recording medium 100 that is identified based on the recording medium identification data received by the management data receiver 310, matches the recording medium 100 that is designated based on the recording medium identification data included in the license certification request, and may determine whether the OS 200 or the updated version can be activated and be used.

The license determination results transmitter 360 transmits to the computer 110 the determination results obtained by the license determination unit 350. Therefore, on condition that it is determined that the OS 200 or the updated version may be activated from the recording medium 100 and be employed, the license determination results transmitter 360 permits the computer 110 to activate the OS 200 or the updated version from the recording medium 100 and set it to the enabled state.

According to the above described license management server 30, the recording medium identification data for the recording medium 100, on which the OS 200 or the updated version is to be stored, is obtained from the OS installation unit 205, and a license can be provided only on condition that the OS 200 is recorded on an appropriate recording medium 100. Therefore, the license management server 300 can prevent the installation of the OS 200 or the updated version from a recording medium 100 on which the unauthorized recording medium identification data is recorded.

On condition that the recording medium identification data is illegally obtained from the recording medium 100, and is copied, with the OS 200, to another recording medium 100, the license management server 300 can employ the access count to inhibit the installation or updating of the OS 200.

Furthermore, since the license management server 300 employs the product identification data to determine whether the installation of the OS 200 should be permitted, the OS 200 can be protected from being installed on condition that an illegal copy of the software product medium 150 is used.

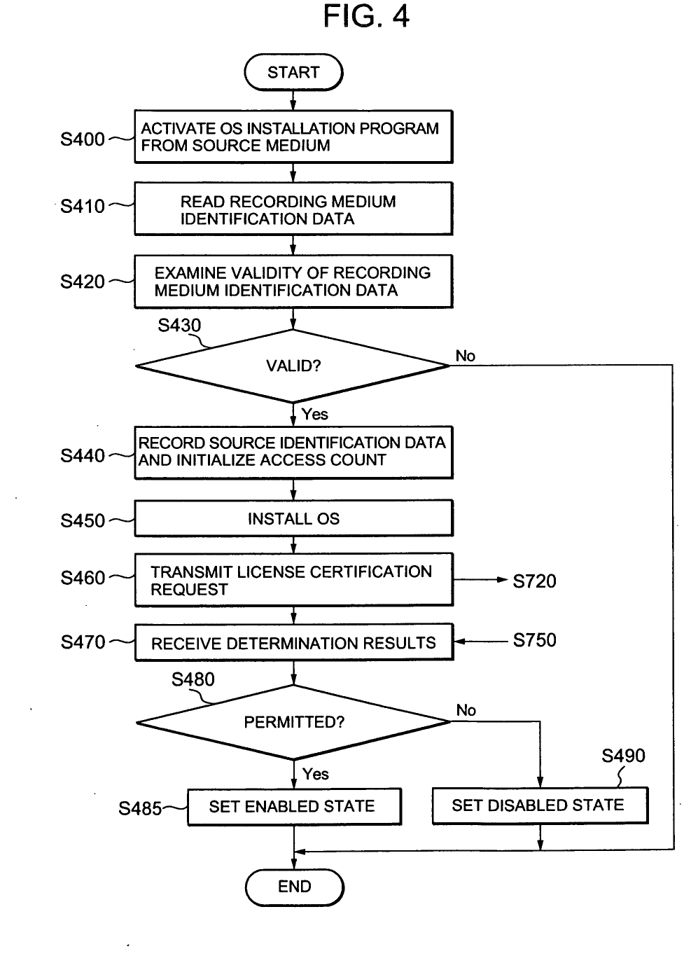

FIG. 4 is a flowchart showing the installation processing for the OS 200 according to the embodiment. First, the recording medium 100 that is used for the installation of the OS 200 is loaded into the computer 110, and the computer 110 reads the installation program for the OS 200 from the software product medium 150 and activates it (S400). The OS installation program is operated as one part of the OS 200, and permits the computer 110 to function as the OS installation unit 205.

Next, upon receiving a request from the OS installation unit 205, the recording medium identification data reader 222 reads recording medium identification data from the recording medium identification data storage area 101 on the recording medium 100, and transmits this data to the recording medium identification data determination unit 207 (S410). Then, the recording medium identification data determination unit 207 determines the validity of the obtained recording medium identification data (S420). On condition that the recording medium identification data determination unit 207 determines that the recording medium identification data is not valid (No at S430), the determination unit 207 instructs the installation unit 214 to halt the installation of the OS 200. As a result, the installation unit 214 halts the installation of the OS 200, and on condition that the recording medium identification data determination unit 207 determines that the recording medium identification data does not satisfy a predesignated condition, the computer 110 is prohibited from activating the OS 200 from the recording medium 100. Through these processes, the OS 200 can prevent the installation of the OS 200 on a recording medium 100 on which illegally generated recording medium identification data is recorded. On condition that the recording medium identification data is determined to be valid (Yes at S430), the recording medium identification data determination unit 207 transmits the recording medium identification data to the license inquiry unit 210 and the installation unit 214.

Following this, based on the recording medium identification data, which is recorded in the recording medium identification data storage area 101 on the recording medium 100, the installation unit 214 generates source identification data for the OS 200, and records this data on the recording medium 100 (S440). At this time, the access count recording unit 212 initializes the access count storage area 105. Then, for program installation, the installation unit 214 records in the boot record 102, the OS storage area 103 and the application program area 106 on the recording medium 100, the OS boot program, the main program for the OS 200 and the application program that have been read from the software data storage area 154 on the software product medium 150 (S450).

Sequentially, the license inquiry unit 210 transmits a license authentication request to the license management server 300 (S460), and receives, from the license management server 300, the determination results obtained in accordance with the license authentication request (S470). On condition that the installation unit 214 receives determination results indicating that the OS 200 may be activated from the recording medium 100 and used (Yes at S480), the installation unit 214 enables the activation of the OS 200 from the recording medium 100 (S485), so that the user can employ the OS 200. On condition that the installation unit 24 does not receive determination results indicating that the OS 200 may be activated from the recording medium 100 and employed, i.e., on condition that the installation unit 214 receives determination results indicting the installation is not permitted (No at S480), the installation unit 214 inhibits the activation of the OS 200 from the recording medium 100 (S490), so that the use of the OS 200 by the user is prevented.

During the above described installation processing, on condition that the OS installation unit 205 obtains the valid recording medium identification data, and receives from the license management server 300 determination results indicating the installation is permitted, the OS 200 can be stored on the recording medium 100 for setting in the enabled state. Further, since the source identification data, which is generated based on the recording medium identification data for the recording medium 100 used for the installation, is recorded, together with the OS 200, on the recording medium 100 during the installation process, the OS activation unit 220 can detect, at the time the OS 200 is activated, that the recording medium 100 at the source is authorized.

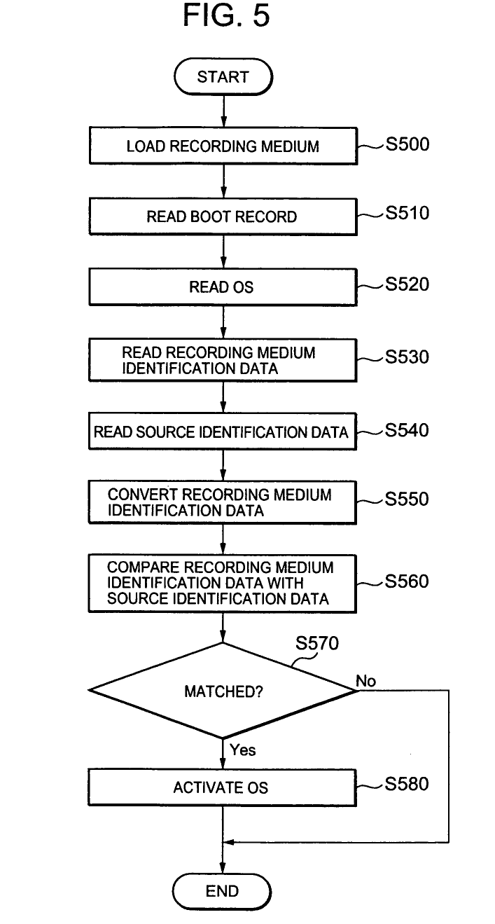

FIG. 5 is a flowchart showing the activation processing for the OS 200 according to the embodiment. First, the recording medium 100 is loaded into the computer 110 (S500), and the computer 110 reads the OS boot program from the boot record 102 on the recording medium 100 and activates the program (S510). On condition that the computer 110 executes the OS boot program, the computer 110 functions as the OS activation unit 220. And then, the function controller 240 reads the program for the OS 200 from the OS storage area 103 and writes the program in an area obtained in the memory of the computer 110 (S520).

Next, upon receiving a request from the recording medium disagreement detector 230, the recording medium identification data reader 222 reads, from the recording medium identification data storage area 101 of the recording medium 100, the recording medium identification data for the recording medium 100 that is the activation source for the OS 200 (S530). More specifically, the recording medium identification data reader 222 is provided as an API, which is part of the function of the OS 200 for the reading of the recording medium identification data. On condition that the API is called by the recording medium disagreement detector 230, the recording medium identification data reader 222 provides the recording medium identification data for the recording medium disagreement detector 230. Similarly, on condition that the API is called by the recording medium identification data determination unit 207 or the installation unit 214 of the OS installation unit 205, the recording medium identification data reader 222 provides the recording medium identification data for the license inquiry unit 210 or the installation unit 214 that is the call source. However, on condition that the API is called by an application program running on the OS 200, the recording medium identification data reader 222 does not provide the recording medium identification data for the application program 260. With this arrangement, the recording medium identification data stored on the recording medium 100 can be protected from being used illegally, i.e., from being obtained and copied to another, unauthorized recording medium 100.

Following this, the source identification data reader 224 reads, from the source identification data storage area 104 on the recording medium 100, the source identification data for the OS 200 to be activated (S540). Then, the recording medium identification data converter 232 of the recording medium disagreement detector 230 performs the same conversion as is used by the installation unit 214 for the generation of the source identification data, and changes the recording medium identification data read by the recording medium identification data reader 222 (S550). Thereafter, the identification data disagreement detector 234 determines whether the source identification data, which is read by the source identification data reader 224, matches the recording medium identification data, which is obtained by the recording medium identification data converter 232 (S560). On condition that these data do not match (No at S570), the identification data disagreement detector 234 determines that the recording medium disagreement state exists.

On condition that the data identification data disagreement detector 234 determines that the recording medium disagreement state exists (No at step S570), the detector 234 halts the activation processing for the OS 200. But on condition that the recording medium disagreement state is not detected (Yes at S570), the identification data disagreement detector 234 continues the activation processing for the OS 200 until it is completed, and thereafter, permits the user to employ the OS main body 250 (S580).

In the above described activation processing, on condition that the recording medium identification data for the recording medium 100 matches the source identification data that is stored on the recording medium 100 during the installation process, the OS activation unit 220 permits the computer 110 to activate and operate the OS 200. Therefore, the contents of the recording medium 100 can be protected from being copied to another, unauthorized recording medium 100, so that the illegal use of the OS 200 can be prevented.

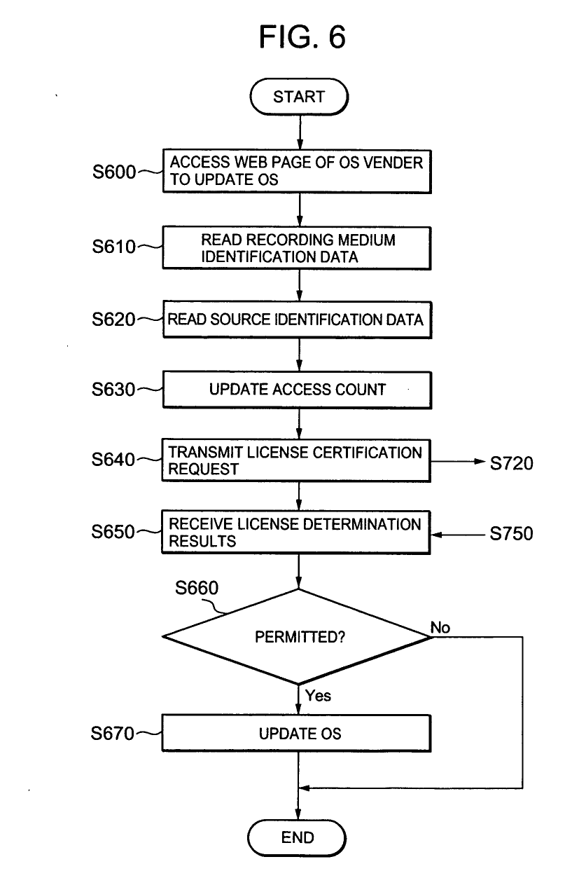

FIG. 6 is a flowchart showing the updating processing performed for the OS 200 according to the embodiment. First, through the OS 200 operated by the computer 110, a user can access the Web page of the OS vender 120 provided by the license management server 300 in order to update the OS 200 (S600). Then, in the same manner as at S530 and S540 in FIG. 4, the recording medium identification data reader 222 and the source identification data reader 224 read the recording medium identification data and the source identification data (S610 and S620). Thereafter, the access count recording unit 212 updates the access count by incrementing the access count recorded in the access count storage area 105 (S630).

Following this, in the same manner as at S460 in FIG. 4, the license inquiry unit 210 transmits a license authentication request to the license management server 300 (S640), and receives, from the license management server 300, the determination results obtained in accordance with the license authentication request (S650). Then, on condition that the installation unit 214 receives, from the license management server 300, determination results indicating that the updated version of the OS 200 may be activated from the recording medium 100 and employed (Yes at S660), the installation unit 214 obtains, from the license management server 300, the updated version of the OS 200, and records the updated version on the recording medium 100 to update the OS 200 (S670). Thereafter, the installation unit 214 enables the updated OS 200 to be activated from the recording medium 100, so that it can be employed by the user. On condition that the installation unit 214 does not receive determination results indicating that the updated version of the OS 200 may be activated from the recording medium 100 and employed (No at S660), the installation unit 214 does not update the OS 200.

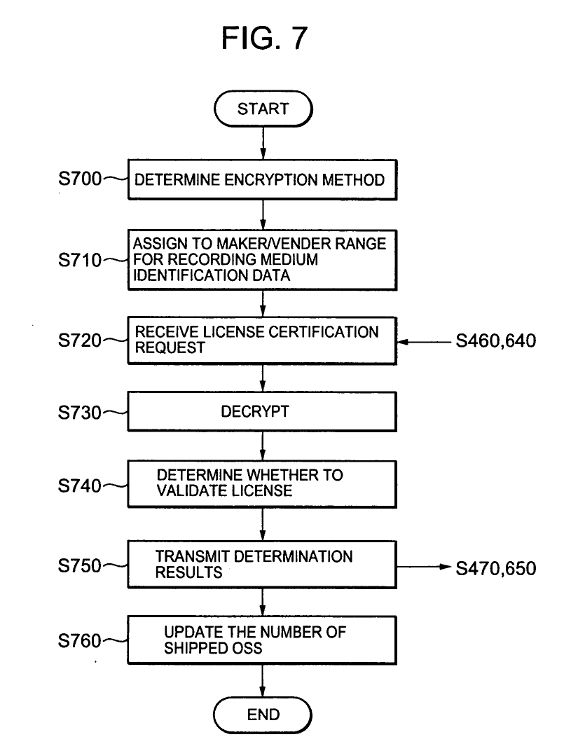

FIG. 7 is a flowchart showing the license authentication processing performed by the license management server 300 according to the embodiment. First, the OS vender 120 decides which encryption method to use to record the recording medium identification data in the recording medium identification data storage area 101 on the recording medium 100, and notifies the maker/vender 130 and the duplication provider 140 (S700). The OS vender 120 employs transmission means to notify the maker/vender 130 of a range wherein the maker/vender 130 can store recording medium identification data in the recording medium identification data storage area 101 of a recording medium 100 that has been produced and sold, and assigns recording medium identification data that is permitted to be recorded therein (S710). More specifically, first, the recording medium management server 135 records, on the recording medium 100, recording medium identification data predesignated by the OS vender 120, and then transmits to the management data receiver 310 of the license management server 300 the recording medium identification data stored on the recording medium 100, so that the license management server 300 can be notified that the recording medium identification data have actually been allocated by the recording medium management server 135.

At S460 in FIG. 4 or at S640 in FIG. 6, the license inquiry receiver 320 receives a license authentication request issued by the installation unit 205 of the computer 110 (S720). Then, the decoder 330 employs a decryption method, which corresponds to the encryption method determined at S700, to decrypt the recording medium identification data that is included in the license authentication request received by the license inquiry receiver 320 (S730). Based on the decrypted recording medium identification data, the license determination unit 350 determines either whether the OS 200 may be stored on the recording medium 100, or whether the OS 200 or the updated version may be activated from the recording medium 100 and employed (S740).

On condition that the license certification request includes the access count and/or product identification data, the license determination unit 350 may employ the access count and/or the product identification data, in addition to the recording medium identification data, to determine either whether the OS 200 may be stored on the recording medium 100 and employed, or whether the OS 200 or the updated version may be activated from the recording medium 100 and employed. That is, on condition that the access count included in the license certification request is equal to or smaller than the access count stored in the access count storage unit 340 for the OS 200, the license determination unit 350 ascertains that an illegal copy of the OS 200 is being employed and does not authenticate the license. On condition that the product identification data included in the license certification request does not satisfy a predesignated condition for coding product identification data, and is an inappropriate value, the license determination unit 350 ascertains the software product medium 150 is an unauthorized copy and does not authenticate the license.

Following this, the license determination results transmitter 360 transmits to the computer 110 the determination results obtained by the license determination unit 350, and permits the installation unit 205, which is operated by the computer 110, to perform the process at S470 in FIG. 4 or at S650 in FIG. 6 (S750). Thereafter, each time the license determination unit 350 outputs determination results indicating that the OS 200 may be activated from the recording medium 100 to be employed, the license determination unit 350 updates the number of shipped OSs 200, so that the number of the OSs 200 shipped and employed by users is regarded as the number of shipments (S760).

Through the above described license certification processing, the recording medium identification data recorded on the recording medium 100 can be decrypted by the license management server 300. Therefore, a program and a key used for decryption need not be stored on the recording medium 100 to permit the computer 110 to perform the decryption, and the recording medium identification data can be protected from being illegally decrypted. Further, since the license management server 300 performs license management based on the access count, in addition to the recording medium identification data, even on condition that the contents of the recording medium 100 are completely duplicated on a plurality of recording media 100, together with the recording medium identification data, the license authentication request obtained from these recording media 100 can be examined and the license prohibited.

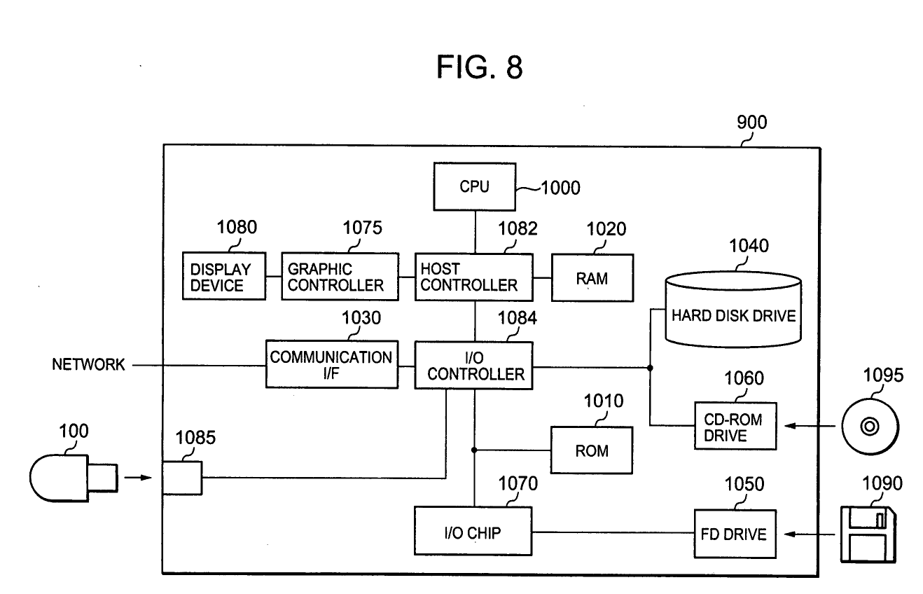

FIG. 8 is a diagram showing an example hardware configuration for a computer 900 according to the embodiment of the invention. The computer 900 for this embodiment comprises: a CPU peripheral section that includes a CPU 1000, a RAM 1020, a graphic controller 1075 and a display device 1080, all of which are interconnected by a host controller 1082; an input/output section that includes a communication interface 1030, a hard disk drive 1040 and a CD-ROM drive 1060, which are connected to the host controller 1082 through an input/output controller 1084; and a legacy input/output section that includes a ROM 1010, a flexible disk drive 1050 and an input/output chip 1070, which are connected to the input/output controller 1084.

The host controller 1082 connects the RAM 1020 to the CPU 1000, which accesses the RAM 1020 at a high transfer rate, and the graphic controller 1075. The CPU 1000, which is operated based on programs stored in the ROM 1010 and the RAM 1020, controls the other, individual sections. The graphic controller 1075 obtains image data that the CPU 100, for example, generates in a frame buffer provided for the RAM 1020, and displays the image data on the display device 1080. The graphic controller 1075 may internally include a frame buffer for storing image data generated, for example, by the CPU 1000.

The input/output controller 1084 connects the host controller 1082 to the communication interface 1030, which is a comparatively fast input/output device for communicating with another device across a network, the hard disk drive 1040 and the CD-ROM drive 1060. The communication interface 1030 communicates with another device via a network. The hard disk drive 1040 is used to store programs and data employed by the CPU 1000 of the computer 900. The computer 900, which is used as the computer 110 into which the recording medium 100 is loaded, may not include the hard disk drive 140 because it employs programs and/or data recorded on the recording medium 100. The CD-ROM drive 1060 reads a program or data from a CD-ROM 1095 and transmits it, through the RAM 1020, to the hard disk drive 1040.

A connector 1085, into which the recording medium 100 is inserted, is connected to the input/output controller 1084 of the computer 900 that is used as the computer 110 into which the recording medium 100 is loaded. The connector 1085 is, for example, a USB connector or a memory card slot, and is used to permit the CPU 100 to employ the program and the data stored on the recording medium 100 that has been loaded.

The input/output controller 1084 is connected to the ROM 1010 and comparatively slow input/output devices, such as the flexible disk drive 1050 and the input/output chip 1070. The ROM 1010 is used to store a boot program executed by the computer 900 on condition that it is activated, and a another program, the execution of which depends on the hardware of the computer 900. The flexible disk drive 1050 reads a program or data from the flexible disk 1090 and transmits it through the RAM 1020 to the hard disk drive 1040. The input/output chip 1070 connects various input/output devices through a parallel port, a serial port, a keyboard port and a mouse port, for example.

A program provided, through the RAM 1020, for the hard disk drive 1040 is stored, for employment by a user, on a recording medium such as the flexible disk 1090, the CD-ROM drive 1095 or an IC card. A program on the recording medium is read and installed, through the RAM 1020, in the hard disk drive 1040 of the computer 900, and is executed by the CPU 1000.

An operating system, stored on the recording medium 100 and activated by the computer 900, includes an OS installation program, an OS boot program and an OS main program. These programs act, for example, on the CPU 1000 and permit the computer 900 to function as the OS installation unit 205, the OS activation unit 220 and the OS main body 250.

The OS installation program includes a license inquiry module, an access count recording module and an installation module. This program, or these modules, act with the CPU 1000, for example, to permit the computer 900 to function as the license inquiry unit 210, the access count recording unit 2112 and the installation unit 214.

The OS boot program includes: a recording medium identification data reading module; a source identification data reading module; a recording medium disagreement detection module, which includes a recording medium identification data conversion module and an identification data disagreement detection module; and a function control module. This program, or these modules, act with the CPU 1000, for example, to permit the computer 900 to function as the recording medium identification data reader 222, the source identification data reader 224, the recording medium disagreement detector 230, which has the recording medium identification data converter 232 and the identification data disagreement detector 234, and the function controller 240.

A license management program, which is installed in the computer 900 and permits the computer 900 to function as the license management server 300, includes a management data reception module, a license inquiry reception module, a decoding module, a license determination module, an access count management module, a license determination module and a license determination results transmission module. This program, or these modules, act with the CPU 1000, for example, to permit the computer 900 to function as the management data receiver 310, the license inquiry receiver 320, the decoder 330, the access count storage unit 340, the license determination unit 350 and the license determination results transmitter 360.

The programs or the modules described above may be stored in an external storage medium. This storage medium can be, for example, the flexible disk 1090, the CD-ROM 1095, an optical recording medium such as a DVD or a PD, a magneto-optical recording medium such as an MD, a tape medium, or a semiconductor memory such as an IC card. Further, a storage device, such as a hard disk or a RAM, that is provided for a server system connected to a special communication network or to the Internet may be employed as a recording medium, and a program may be provided, via the network, for the computer 900.

The present invention has been described by referring to the preferred embodiment. However, the technical scope of the invention is not limited to the embodiment, and it will be obvious to one having ordinary skill in the art that the embodiment of the invention can be variously modified or improved. From the description of the claims of the present invention, it is apparent that within the technical scope of the invention, modification of the embodiment and an improved embodiment can be included.

In the drawings and specifications there has been set forth a preferred embodiment of the invention and, although specific terms are used, the description thus given uses terminology in a generic and descriptive sense only and not for purposes of limitation.

1. A product comprising:
a computer-usable removable recording medium having computer readable operating system code stored therein for reading and activation by a computer into which the recording medium is loaded, the computer readable operating system code including:
recording medium identification data code, for reading, from a storage area on a recording medium, recording medium identification data for identifying the recording medium on which the operating system is recorded;
source identification data code for reading, from a storage area on the recording medium, source identification information, recorded in correlation with the operating system, designating the recording medium that is permitted to serve as a data source for activating the operating system;
recording medium disagreement code, for detecting a recording medium disagreement state wherein the recording medium designated by the source identification data does not match the recording medium identified by the recording medium identification data; and
operating system function code, for permitting the computer, on condition that a recording medium disagreement state is not detected, to activate the operating system and to set the operating system to an enabled state, the operating system function code, for disabling, on condition that a recording medium disagreement state is detected, at least one operating system function that is available on condition that a recording medium disagreement state is not detected.

2. A product according to claim 1, wherein, on condition that the recording medium disagreement state is detected during the activation process for permitting the computer to activate the operating system, the operating system function code halts the activation process, so that the usage of the operating system for the computer is disabled.

3. A product according to claim 1,
wherein, on condition that an API, which is provided as part of the operating system for reading the recording medium identification data, is called for by the recording medium disagreement code, the recording medium identification data code provides the recording medium identification data for the recording medium disagreement code; and
wherein, on condition that the API is called for by an application program operated by the operating system, the recording medium identification data code does not provide the recording medium identification data for the application program.

4. A product according to claim 1, wherein the computer readable operating system code further includes:
license inquiry code for transmitting a license certification request, which includes the recording medium identification data read by the recording medium identification data code, to a license management server for employing the recording medium identification data to determine whether the operating system may be activated from the recording medium and used, and for receiving the determination results obtained by the license management server; and
installation code for, on condition that the license inquiry code does not receive the determination results indicating that the operating system may be activated from the recording medium and employed, inhibiting the computer from activating the operating system from the recording medium,
wherein the installation code employs the recording medium identification data to generate the source identification data for the operating system, and stores on the recording medium, with the operating system, the source identification data.

5. A product according to claim 4,
wherein the installation code performs conversion for the recording medium identification data to avoid inverse conversion, and generates the source identification data; and
wherein the recording medium disagreement code includes
recording medium identification data conversion code for performing, for the recording medium identification data read by the recording medium identification data code, the conversion used for the generation of the source identification data,
identification data disagreement code for detecting the recording medium disagreement state on condition that the source identification data does not match the recording medium identification data obtained by the conversion.

6. A product according to claim 4, wherein the computer readable operating system code further includes:
recording medium identification data determination code,
wherein, on condition that the recording medium identification data determination code determines that the recording medium identification data does not satisfy the predesignated condition, the installation code prohibits the computer from activating the operating system from the recording medium.

7. A product according to claim 4, wherein the computer readable operating system code further includes:
access code for counting the number of times that the operating system has accessed the license management server, and for recording the number of access times on the recording medium,
wherein the license inquiry code transmits, to the license management server, the recording medium identification data and the number of access times that are read by the recording medium identification data code, and
wherein the license inquiry code receives determination results, indicating whether the recording of the operating system on the recording medium should be permitted, that are obtained by the license management server through a determination process based on the recording medium identification data and the number of access times.

8. A method comprising:
producing computer executable program code;
providing the program code to be deployed to and executed on a first computer system, the program code including operating system code which is to be written on a removable recording medium and executed by a bootable computer into which the recording medium is loaded;
the program code including:
recording medium identification data code, for reading, from a storage area on a recording medium, recording medium identification data for identifying the recording medium on which the operating system is recorded;
source identification data code for reading, from a storage area on the recording medium, source identification information, recorded in correlation with the operating system, designating the recording medium that is permitted to serve as a data source for activating the operating system;
recording medium disagreement code, for detecting a recording medium disagreement state wherein the recording medium designated by the source identification data does not match the recording medium identified by the recording medium identification data; and
operating system function code, for permitting the bootable computer, on condition that a recording medium disagreement state is not detected, to activate the operating system and to set the operating system to an enabled state, the operating system function code, for disabling, on condition that a recording medium disagreement state is detected, at least one operating system function that is available on condition that a recording medium disagreement state is not detected.

9. A method according to claim 8, wherein, on condition that the recording medium disagreement state is detected during the activation process for permitting the computer to activate the operating system, the operating system function code halts the activation process, so that the usage of the operating system for the computer is disabled.

10. A method according to claim 8,
wherein, on condition that an API, which is provided as part of the operating system for reading the recording medium identification data, is called for by the recording medium disagreement code, the recording medium identification data code provides the recording medium identification data for the recording medium disagreement code; and
wherein, on condition that the API is called for by an application program operated by the operating system, the recording medium identification data code does not provide the recording medium identification data for the application program.

11. A method according to claim 8, wherein the program code further includes:
license inquiry code for transmitting a license certification request, which includes the recording medium identification data read by the recording medium identification data code, to a license management server for employing the recording medium identification data to determine whether the operating system may be activated from the recording medium and used, and for receiving the determination results obtained by the license management server; and
installation code for, on condition that the license inquiry code does not receive the determination results indicating that the operating system may be activated from the recording medium and employed, inhibiting the computer from activating the operating system from the recording medium,
wherein the installation code employs the recording medium identification data to generate the source identification data for the operating system, and stores on the recording medium, with the operating system, the source identification data.

12. A method according to claim 11,
wherein the installation code performs conversion for the recording medium identification data to avoid inverse conversion, and generates the source identification data; and
wherein the recording medium disagreement code includes
recording medium identification data conversion code for performing, for the recording medium identification data read by the recording medium identification data code, the conversion used for the generation of the source identification data,
identification data disagreement code for detecting the recording medium disagreement state on condition that the source identification data does not match the recording medium identification data obtained by the conversion.

13. A method according to claim 11, wherein the program code further includes:
recording medium identification data determination code,
wherein, on condition that the recording medium identification data determination code determines that the recording medium identification data does not satisfy the predesignated condition, the installation code prohibits the computer from activating the operating system from the recording medium.

14. A method according to claim 11, wherein the program code further includes:
access code for counting the number of times that the operating system has accessed the license management server, and for recording the number of access times on the recording medium,
wherein the license inquiry code transmits, to the license management server, the recording medium identification data and the number of access times that are read by the recording medium identification data code, and
wherein the license inquiry code receives determination results, indicating whether the recording of the operating system on the recording medium should be permitted, that are obtained by the license management server through a determination process based on the recording medium identification data and the number of access times.

15. A method according to claim 8 wherein the first computer and the bootable computer are the same computer.

16. Apparatus comprising:
a license management server which manages a license for an operating system, recorded on a removable recording medium, the operating system being read and activated by a computer into which the recording medium is loaded, the license management server further comprising:
a management data receiver which receives, from a recording medium management server that manages the recording medium, recording medium identification data, for identifying the recording medium, that are recorded in advance in a storage area on the recording medium;
a license inquiry receiver which receives, from the computer that activates the operating system by accessing the recording medium, a license authentication request including recording medium identification data that are read from a storage area on the recording medium;
a license determination unit, which determines, on condition that the recording medium identified by the recording medium identification data received by the management data reception unit matches the recording medium designated by the recording medium identification data included in the license authentication request, that by accessing the recording medium the operating system may be activated and set in an enabled state; and
a license determination results transmitter, which permits, on condition that it is determined that by accessing the recording medium the operating system may be activated and set in an enabled state, the computer to activate and set the operating system in an enabled state by accessing the recording medium.

17. Apparatus according to claim 16, wherein the license management server further comprises:
a decoder which decodes the recording medium identification data that is encrypted and recorded in advance on the recording medium and that is included in the license certification request received by the license inquiry unit,
wherein, on condition that the recording medium identification data received by the management data receiver matches the recording medium identification data decrypted by the decoder, the license determination unit determines that the operating system may be activated from the recording medium and employed.

18. A product comprising:
a computer usable recording medium having computer readable program code stored therein, the computer readable program code in said product being effective to manage one or more licenses for an operating system to be read and activated by a computer into which the recording medium is loaded, the program code including:
management data code for receiving, from a recording medium management server that manages the recording medium, the recording medium identification data, for identifying the recording medium, that are recorded in advance in a storage area on the recording medium;
license inquiry code for receiving, from the computer that activates the operating system by accessing the recording medium, a license authentication request including recording medium identification data that are read from a storage area on the recording medium;
a license determination code, for determining, on condition that the recording medium identified by the recording medium identification data received by the management data reception unit matches the recording medium designated by the recording medium identification data included in the license authentication request, that by accessing the recording medium the operating system may be activated and set in an enabled state; and
a license determination results transmittal code, for permitting, on condition that it is determined that by accessing the recording medium the operating system may be activated and set in an enabled state, the computer to activate and set the operating system in an enabled state by accessing the recording medium.

19. A method comprising:
a recording medium identification data reading step of the computer reading, from a storage area on a removable recording medium having an operating system recorded thereon which is read and activated by a computer into which the recording medium is loaded, recording medium identification data which identifies the recording medium on which the operating system is recorded;
a source identification data reading step of the computer reading, from a storage area on the recording medium, source identification information, recorded in correlation with the operating system, designating the recording medium that is permitted to serve as a data source for activating the operating system;
a recording medium disagreement detection step of the computer detecting a recording medium disagreement state wherein the recording medium designated by the source identification data does not match the recording medium identified by the recording medium identification data; and
a function control step of, on condition that a recording medium disagreement state is not detected, the computer activating the operating system and setting the operating system to an enabled state, or on condition that a recording medium disagreement state is detected, the computer disabling at least one available operating system function on condition that a recording medium disagreement state is not detected.

20. A method according to claim 19, further comprising:
a license inquiry transmission step of the computer transmitting, to the license management server, a license certification request that includes the recording medium identification data read at the recording medium identification data reading step;
a management data transmission step of the recording medium management server, which manages the recording medium, transmitting the recording medium identification data, which is recorded in advance on the recording medium, to the license management server, which manages the license for the operating system;
a license determination step of, on condition that the recording medium identified based on the recording medium identification data, which is received at the management data transmission step, matches the recording medium designated based on the recording medium identification data, which is included in the license certification request, the license management server determining that the operating system may be activated from the recording medium and employed;
a license determination results transmission step of the license management server transmitting, to the computer, the determination results obtained at the license determination step; and
an installation step of, on condition that the computer receives the determination results indicating that the operating system may be activated from the recording medium and employed, the computer activating the operating system from the recording medium and setting the operating system in an enabled state.

21. A removable recording medium, on which is recorded an operating system that is to be read and activated by a computer, comprising:
a recording medium identification data storage area, wherein recording medium identification data for identifying the recording medium are stored;
an operating system storage area, wherein the operating system is stored; and
a source identification data storage area, wherein source identification data, for designating a recording medium that is permitted to act as a source for the activation of the operating system, are stored in correlation with the operating system,
wherein, on condition that the computer does not detect a recording medium disagreement state, wherein the recording medium designated by the source identification data does not match the recording medium identified by the recording medium identification data, the operating system permits the computer to activate and set the operating system in an enabled state, and
wherein, on condition that the computer detects a recording medium disagreement state, the operating system permits the computer to disable at least one operating system function that is set to the enabled state on condition that the computer does not detect a recording medium.
